(19) United States
(12) Patent Application Publication
(10) Pub. No.: US 2009/0125836 A1
(43) Pub. Date: May 14, 2009

(54) IMAGE OUTPUT DEVICE

(76) Inventors: Akihiro Yamamoto, Kanagawa (JP); Kenji Nishimura, Mie (JP); Toshiaki Mori, Osaka (JP); Atsushi Iisaka, Osaka (JP); Takeshi Furukawa, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/294,075

(22) PCT Filed: Apr. 10, 2007
(86) PCT No.: PCT/JP2007/057863

§ 371 Date: Sep. 23, 2008

(30) Foreign Application Priority Data
Apr. 20, 2006 (JP) 2006-116997

(51) Int. Cl. G06F 3/048; G06F 15/16; G06F 17/30

(52) U.S. Cl. 715/781; 709/203; 709/219; 707/104.1; 707/E17.019; 707/E17.008

(57) ABSTRACT

An object of the present invention is to provide an image output device capable of performing a screen switching without causing a user to feel discomfort or anxiety. An in-vehicle image output device 101 receives moving image data from a content storing section 110 via a communication section 102, and the received moving image data is decoded in a decoding section 103. An effect processing controlling section 106 calculates, as an effect processing execution time, a time period required from when an instruction to reproduce the moving image data is received to when the reproduction of the moving image data starts, and causes an effect processed image generating section 107 to generate an image in which a current screen is shifted to a subsequent screen. After displaying the effect processed image, the control section 105 changes an output so as to display an image of the moving image data.

### TECHNICAL FIELD

The present invention relates to an image output device which executes contents accumulated in a recording device, and more particularly to an image output device which controls a display at the time of a screen switching performed when moving image data is reproduced.

### BACKGROUND ART

In recent years, an image output device which reproduces a content, such as a moving image, accumulated in a server installed at a remote location has become commercially practical. Digital moving data typified by the content is compressed using a compression scheme such as MPEG-2 (Moving Picture Expert Group phase 2), and such compressed digital moving data is reproduced after being decoded by means of a dedicated hardware or software decoder.

In the case where such compressed data is reproduced, a reproduction quality can be maintained even when the compressed data is reproduced while receiving the digital moving data via a network by performing data buffering, which temporarily stores a certain amount of data in a memory.

Due to the data buffering, however, the reproduction of the digital moving data is not started immediately after a user performs an operation to reproduce the digital moving data. Furthermore, even if the user can set an amount of data to be temporarily stored for data buffering, a time period required from when the data buffering is completed to when the data reproduction is, started is dependant on an effective communication speed in the case where the data is received via the network, and the user can not recognize the aforementioned time period.

As such, in the case where the data is received via the network, a time period required until the reproduced image is displayed on a screen varies depending on a communication speed or settings of buffers used for an application.

Furthermore, not only when a content is reproduced via the network, but also when a content accumulated in a recording device included in the image output device is reproduced, a read speed or transfer speed of the recording device or a response speed of a processing device affects a time period until the reproduction is started, and therefore the user cannot recognize the above-described time period.

In order to solve such a problem, a moving image display device disclosed in patent document 1 proposes that a still image be displayed if the operation does not catch up with the processing time due to reading the moving image data or the like when displaying a moving image of a subsequent screen.

Moreover, when a screen switching is performed, a music reproduction device disclosed in patent document 2 deletes a current screen or applies an effect processing to an appearance of a subsequent screen (fade-in or fade-out, for example), thereby realizing an appealing effect of a screen transition or an improved entertainment for the user.

[Patent document 1] Japanese Laid-Open Patent Publication No. 2001-67489

[Patent document 2] Japanese Laid-Open Patent Publication No. 2004-157243

### DISCLOSURE OF THE INVENTION

### Problems to be Solved by the Invention

In the moving image display device disclosed in patent document 1, the user has to view the same still image for a while, and if this time becomes prolonged, the user feels discomfort about being so slow to start the reproduction or feels anxiety about whether the reproduction is actually started.

Furthermore, in the music reproduction device disclosed in patent document 2, the effect processing is applied at the time of the screen switching so as to reduce the discomfort of the user. Yet, the user cannot recognize how long the effect processing would take to be executed. Moreover, if the reproduction of the moving image does not start even after the screen switching is performed, a still image is displayed similarly to the moving image display device disclosed in patent document 1.

The present invention solves the problem mentioned above. Specifically, an object of the present invention is to provide an image output device capable of smoothly performing a screen switching when the reproduction of the content is started, thereby not causing a user to feel any discomfort or any anxiety.

### Solution to the Problems

It is assumed that an image output device according to the present invention outputs a plurality of pieces of image data to a display section. The present invention comprises: a display section for displaying one of the pieces of image data; an input section for receiving an operation of a user; an effect processing controlling section for calculating, based on a time period required for retaining buffered data corresponding to an amount sufficient to reproduce the one of the pieces of image data of a predetermined content received by the input section, an effect processing execution time indicating a time period required for executing an effect processed image displayed while a screen switching is performed; an effect processed image generating section for generating the effect processed image in accordance with the effect processing execution time; and a control section for displaying the effect processed image in the display section.

Thus, during a time period from when the user operates to issue an instruction to when the content is started, a display control is effectively performed. For example, it becomes possible to display a next image immediately after the screen switching is performed.

Furthermore, it is preferable that the image output device further comprises a communication section for acquiring, via a network, the contents having been accumulated in a content storing section installed at a remote location, wherein the effect processing controlling section calculates the effect processing execution time based on an effective communication speed between the communication section and the content storing section.

Thus, even if moving image data is stored at a remote location, it becomes possible to start the reproduction of the moving image data immediately after the screen switching is performed.

Furthermore, it is preferable that the communication section acquires, via a network, the contents having been accumulated in content storing sections installed at a plurality of remote locations, and the effect processing controlling section calculates the effect processing execution time corresponding to the effective communication speed between the communication section and each of the content storing sections.

Thus, in the case where the user selects, from among a plurality of pieces of moving image data stored at the remote locations, one of the pieces of moving image data, a display control is effectively performed even if any of the pieces of moving image data is selected. Therefore, it becomes possible to start the reproduction of any of the pieces of moving image data immediately after the screen switching is performed.

Furthermore, it is preferable that the image output device further comprises a content storing section for accumulating the contents, wherein the effect processing controlling section calculates the effect processing execution time based on a time period required for reading buffered data corresponding to an amount sufficient to reproduce the one of the pieces of image data from the content storing section.

Thus, even in the case where the content storing section is included in the image output device, it becomes possible to start the reproduction of the moving image data immediately after the screen switching is performed.

Furthermore, it is preferable that the effect processing controlling section calculates the effect processing execution time at regular time intervals.

Thus, when an instruction to output the image data of the content is received, it becomes possible to generate an effect processed image by means of the effect processing execution time having been calculated.

Furthermore, it is preferable that the image output device further comprises a DB managing section for recording a database file which manages the contents having been accumulated, wherein the DB managing section records still image data corresponding to each of the contents having been accumulated, and the effect processed image generating section generates the effect processed image by means of the still image data.

Furthermore, it is preferable that the image output device is installed in a mobile unit.

Thus, even in the mobile unit whose effective communication speed is unstable, it becomes possible to start the reproduction of the moving image data immediately after the screen switching is performed.

### EFFECT OF THE INVENTION

As described above, according to the present invention, it becomes possible to provide an image output device capable of not causing the user to feel any discomfort or anxiety due to a display control of screen switching performed when the reproduction of the content is started.

### BRIEF DESCRIPTION OF THE DRAWINGS

FIG. 1 is a block diagram illustrating an in-vehicle image output device according to an embodiment of the present invention.

FIG. 2 is a diagram illustrating an exemplary database file according to the embodiment of the present invention.

FIG. 3 is a flowchart illustrating a moving image data viewing process according to the embodiment of the present invention.

FIG. 4 is a diagram illustrating an exemplary moving image menu screen according to the embodiment of the present invention.

FIG. 5 is a diagram illustrating an exemplary effect processed image according to the embodiment of the present invention.

### DESCRIPTION OF THE REFERENCE CHARACTERS

101 in-vehicle image output device
102 communication section
103 decoding section
104 DB managing section
105 control section
106 effect processing controlling section
107 effect processed image generating section
108 input section
109 display section
110 content storing section
201 database file
401 moving image data list
402 cursor
403, 404 button
501 start image
502, 503 transitional image
504 end image

### BEST MODE FOR CARRYING OUT THE INVENTION

Hereinafter, an image output device according to an embodiment of the present invention will be described in detail with respect to the drawings. The present embodiment assumes that the image output device is installed in a vehicle and is a mobile device. In the following descriptions, the image output device is denoted as an in-vehicle image output device 101. Furthermore, it is also assumed that a content storing section 110, which communicates with the in-vehicle image output device 101 to perform transmission and reception and which stores contents such as moving image data or music data, is installed in a house, for example.

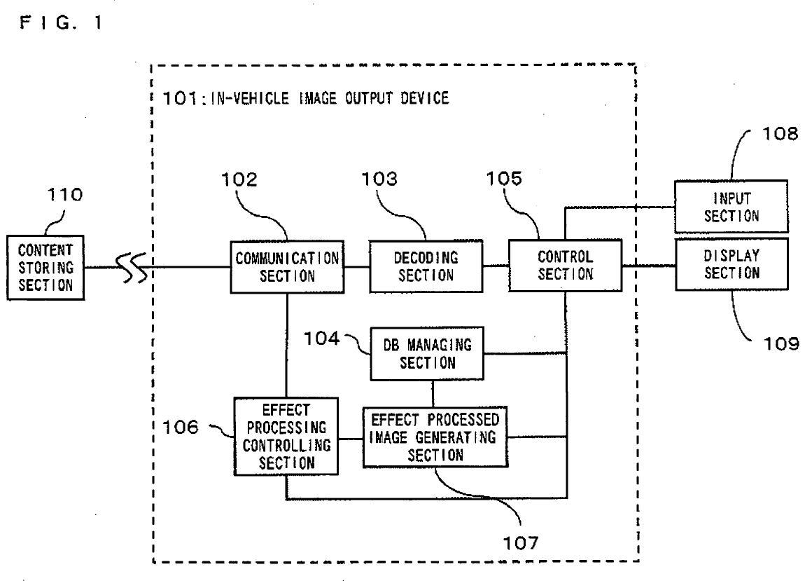

In FIG. 1, the in-vehicle image output device 101 comprises a communication section 102, a decoding section 103, a DB managing section 104, a control section 105, an effect processing controlling section 106, and an effect processed image generating section 107. Also, the in-vehicle image output device 101 is connected to an input section 108 and a display section 109.

The communication section 102 communicates with the content storing section 110. The communication is performed by means of a wireless LAN (an IEEE802.11a, 11b, 11g or the like) via the Internet, for example. Note that the present invention is not limited to the wireless LAN to perform communication. The communication may be performed by means of other communication devices such as cellular phones. Furthermore, the communication may be performed by means of portable terminals through a P2P communication, instead of the Internet.

The decoding section 103 receives digital moving image data transmitted from the content storing section 110 (hereinafter, referred to as moving image data and the present embodiment assumes that the moving image data acquired through communication is reproduced) via the communication section 102 so as to decode the received moving image data. The moving image data is compressed using MPEG-2 (Moving Picture Experts Group phase 2), for example. Then, the decoding section 103 outputs the decoded moving image data to the control section 105. Note that a compression scheme for the moving image data is not limited to MPEG-2. The moving image data may be compressed using other compression schemes.

The DB managing section 104 is an HDD (Hard Disk Drive), for example, which records a database file for managing digital contents such as a plurality of pieces of moving image data or music data. A list of digital contents which can be reproduced by a user, for example, is managed in the database file. Furthermore, in the present embodiment, still image data of a head frame corresponding to each of the pieces of moving image data managed in the database file is recorded in the DB managing section 104.

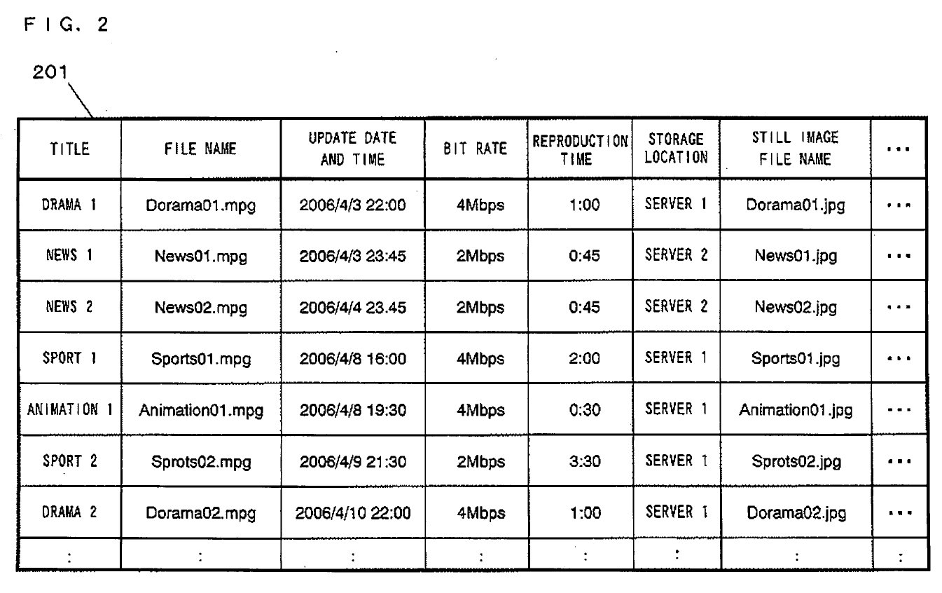

FIG. 2 shows an exemplary database file of the plurality of pieces of moving image data. As shown in FIG. 2, a database file 201 contains various information regarding each of thepieces of moving image data such as a title, a file name, an update day and time, a corresponding still image file name and the like. Note that the actual database file 201 is recorded as digital data in the DB managing section 104. Contents of the database file 201 will be described later.

The control section 105 controls an output of an image signal to the display section 109. Specifically, the control section 105 outputs an image signal to the display section 109, performing switching between the decoded moving image outputted from the decoding section 103, a menu screen created based on the database file read from the DB managing section 104, and an effect processed image outputted from the effect processed image generating section 107. The effect processed image indicates an image to which special effects are applied such that a screen is switched from a current image to a next image, and is a wipe image, for example. Furthermore, the control section 105 instructs the effect processing controlling section 106 to prepare to generate the effect processed image at an appropriate timing.

The effect processing controlling section 106 calculates an effect processing execution time, which is a time period required until each content stored in the content storing section 110 is outputted to the display section 109. Hereinafter, the details of this process according to the present embodiment will be described. Upon receiving an instruction to prepare to generate the effect processed image from the control section 105, the effect processing controlling section 106 accesses the content storing section 110 via the communication section 102 in order to measure an effective communication speed with respect to the content storing section 110 which stores the contents. Then, the effect processing controlling section 106 calculates the effect processing execution time, which is a time period required for executing an effect processed image by means of the measured effective communication speed, and instructs the effect processed image generating section 107 to generate the effect processed image. In response to the instruction to generate the effect processed image, the effect processed image generating section 107 generates an effect processed image according to the effect processing execution time so as to be outputted to the control section 105. This process will be described later in detail.

The input section 108 is a remote control, for example, for transmitting a user operation command to the in-vehicle image output device 101. Note that the input section 108 may be a voice input microphone, and the user may operate the input section 108 through voice recognition or other input methods may be used. Further, in the present embodiment, the input section 108 is connected to the in-vehicle image output device 101. However, the input section 108 may be included in the in-vehicle image output device 101 as a touch panel, for example, with which a display screen is integrated.

The display section 109 is a liquid crystal display, for example, for displaying an image outputted from the in-vehicle image output device 101. Note that the display section 109 may be an EL (electroluminescence) display or a CRT other than a liquid crystal display. Furthermore, in the present embodiment, the display section 109 is connected to the in-vehicle image output device 101. However, the display section 109 may be included in the in-vehicle image output device 101.

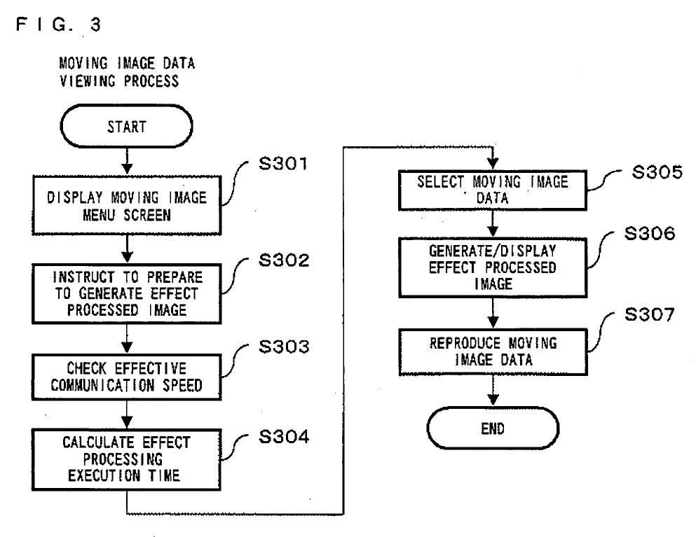

FIG. 3 is a flowchart of a moving image data viewing process, illustrating a process flow executed when the user views one of the pieces of moving image data. Hereinafter, the details of the process flow will be described.

Firstly, the user displays, on the display section 109, a moving image menu screen for selecting one of the pieces of moving image data to be reproduced (step S301). Specifically, the control section 105 reads a database file 201 stored in the DB managing section 104, creates a moving image menu screen based on the read database file, and then outputs the moving image menu to the display section 109. This operation is executed by selecting a moving image menu from a top menu screen (which is omitted in the flowchart of the moving image data viewing process shown in FIG. 3), for example. Or, a dedicated button may be provided in the input section 108 so as to prompt the user to push down the dedicated button, thereby displaying the moving image menu screen.

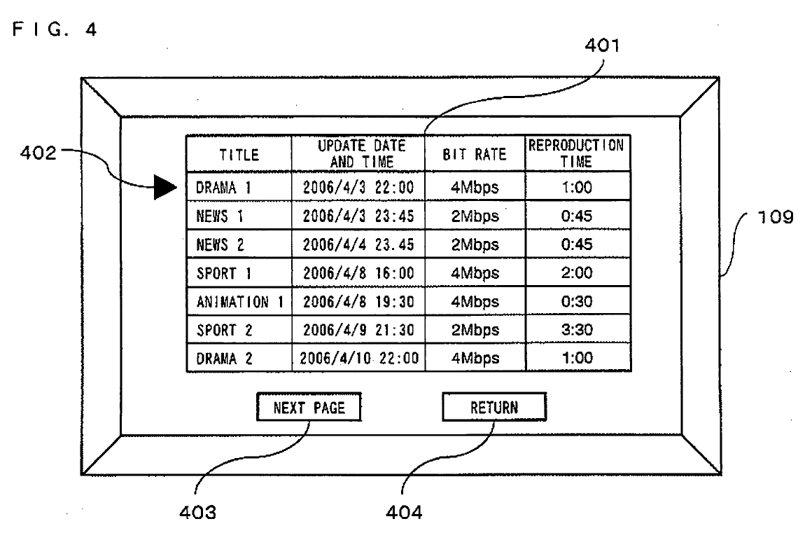

FIG. 4 is an exemplary moving image menu screen displayed on the display section 109. On the display section 109, a moving image data list 401 corresponding to information regarding the plurality of pieces of moving image data stored in the database file 201 is displayed. A cursor 402 which is displayed on the left side of a title column of the moving data list 401 indicates one of the pieces of moving image data currently selected by the user, and is operated freely by the input section 108. In FIG. 4, the cursor 402 is positioned at a title “drama 1”, and when an instruction received from the input section 108 indicates that one of the pieces of moving image data to be reproduced has been determined in this state, apiece of the moving image data of “drama 1” is selected. The button 403 is a button for displaying a next page of the moving data list 401, and the user selects the button 403, thereby displaying the next page of the moving image data list 401. A button 404 is a button for returning to an immediately preceding screen.

Next, items of the moving data list 401 will be described. The displayed items (“title”, “update date and time”, “bit rate” and “reproduction time”) of the moving image data list 401 shown in FIG. 4 correspond to information included in the database file 201. The database file 201 includes various information other than the items displayed in the moving image data list 401. Note that the items displayed in the moving image data list 401 are not limited to the items shown in FIG. 4. Other items may be added or any of the currently-displayed items may be deleted. Furthermore, a new item to be displayed in the list may be created based on the contents of the database file 201, and the newly created item may be displayed accordingly. The items included in the database file 201 are also not limited to the items shown in FIG. 2.

When the moving image menu screen is displayed in step S301, the control section 105 instructs the effect processing controlling section 106 to prepare to generate an effect processed image (step S302).

Next, the effect processing controlling section 106, which has been instructed to prepare to generate the effect processed image, measures a current effective communication speed between a storage location of each of the pieces of moving image data included in the moving image data menu screen and the in-vehicle image output device 101 (step S303).

Taking the moving data list 401 as an example, the plurality of pieces of moving image data included in the moving image menu screen correspond to seven pieces of moving image data whose “titles” are “drama 1”, “news 1”, “news 2”, “sport 1”, “animation 1”, “sport 2” and “drama 2”. That is, it is preferable to measure the effective communication speeds, with respect to the content storing section 110, of all pieces of moving image data selectable from the displayed moving image menu screen. This is because it is necessary to finish, for each of the pieces of selectable moving image data, measuring the effective communication speed and calculating the effect processing execution time, until the user selects one of the pieces of moving image data. Although a storage location of each of the pieces of moving image data is not displayed in the moving data list 401, the storage location is recorded in a “storage location” of the database file 201. The five pieces of moving image data whose titles are “drama 1”, “sport 1”, “animation 1”, “sport 2” and “drama 2” are stored in a server 1, and the two pieces of moving image data whose titles are “news 1” and “news 2” are stored in a server 2. Note that in the database file 201, the “server 1” or the “server 2” are recorded as the “storage location”. However, information which can specify the server 1 or 2 such as an IP address of the server 1 or 2 may be recorded as the storage location. It is assumed that the server 1 and the server 2 are installed in a house, and can be accessed from outside the house.

Therefore, in the present embodiment, the server 1 and server 2 are the content storing section 110 which is connected to the in-vehicle image output device 101. Therefore, the effect processing controlling section 106, which has been instructed to prepare to generate an effect processed image, accesses the server 1 or the server 2 via the communication section 102 in order to measure a current effective communication speed between the in-vehicle image output device 101 and the server 1 or 2. Specifically, a file having a certain specific size (1 Mbyte:M=1000,000, for example) is transmitted to the server 1 or the server 2, for example, so as to measure a time period required until the server 1 or 2 completes reception of the file, thereby calculating the effective communication speed.

Then, the effect processing execution time, which is a time period required for executing an effect processing on each of the pieces of moving image data, is calculated by means of the effective communication speed calculated in step S303 (step S304). This process is executed in the effect processing controlling section 106. Specifically, a time period required for data buffering, i.e., a time period required until the reproduction of each of the pieces of moving image data can be started is calculated based on the effective communication speed and a bit rate of each of the pieces of moving image data.

For example, in the case of “drama 1” indicated by the cursor 402 shown in FIG. 4, it is assumed that a buffer size required for the reproduction is a data amount corresponding to five seconds. In this case, a time period required until a data amount corresponding to 4 Mbps (bit/second)×5 seconds=20 Mbit is received is calculated. When it is assumed that the effective communication speed with respect to the server 1 is 10 Mbps (bit/second), the effect processing execution time will be 20÷10=2 seconds. As described above, the effect processing execution time of each of the pieces of moving image data is calculated.

The processes of steps S303 and S304 are executed separately from a process executed based on the input section 108 operated by the user, and therefore the user can operate the input section 108 as usual without becoming aware of the processes of steps S303 and S304.

Note that data to be buffered is stored in a temporary recording section, which is not shown, such as a RAM (Random Access Memory).

Then, the user selects one of the pieces of moving image data to be viewed via the input section 108 (step S305). The present embodiment assumes that “drama 1” is selected, for example.

Next, the effect processed image generating section 107 generates an effect processed image so as to be outputted to the control section 105 (step S306). Specifically, the effect processed image generating section 107 receives, from the control section 105, still image data of an image currently displayed on the display section 109 (hereinafter, referred to as a first still image). Furthermore, the effect processed image generating section 107 reads, from the DB managing section 104, a head frame of one of the pieces of moving image data selected in step S305, i.e., still image data of a next image (hereinafter, referred to as a second still image). Then, an effect processed image for switching a screen from the first still image to the second still image while applying an effect processing to the images is outputted to the control section 105. The control section 105 outputs the effect processed image to the display section 109.

When a display of the effect processed image is completed, the second still image is displayed on the display section 109. Then, the one of the pieces of moving image data received from the content storing section 110 (the server 1 in case of “drama 1”) is decoded in the decoding section 103, so as to be displayed on the display section 109 via the control section 105.

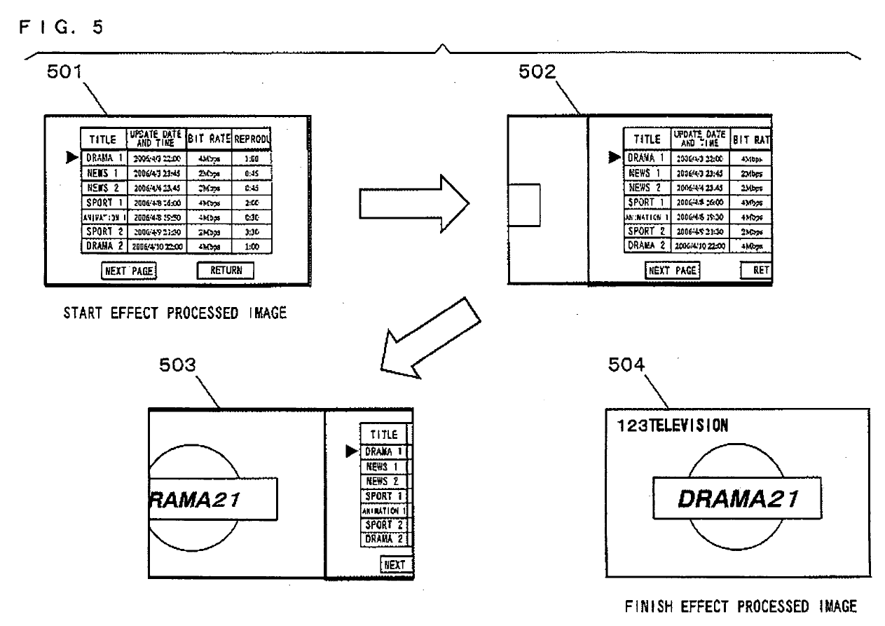

FIG. 5 is a diagram illustrating an exemplary state where a screen is switched from the first still image to the second still image, i.e., an exemplary effect processed image. A start image 501 shows the first still image currently displayed on the display section 109. Then, the first still image is being shifted to the second still image as shown in the transitional images 502 and 503. Thereafter, the effect processed image finishes with a still image of a head frame of “drama 1”, i.e., an end image 504 which is the second still image.

In an example of FIG. 5, the currently-displayed first still image is being shifted to the right of the screen. At the same time, the second still image appears accordingly from the left of the screen. Although FIG. 5 shows only four images, a number of images required while the screen is switched from the start image 501 to the end image 504 are continuously displayed. A time period required until the screen is switched from the start image 501 to the end image 504 is the effect processing execution time calculated in step S306. Specifically, in the case of “drama 1”, it takes two seconds to switch from the start image 501 to the end image 504. During the transition from the start image 501 to the end image 504, the first still image is shifted to the second still image at a uniform speed, for example.

For two seconds to switch from the start image 501 to the end image 504, data buffering for reproducing the one of the pieces of moving image data is completed. Therefore, after the end image 504 is displayed, the one of the pieces of moving image data starts to be continuously reproduced.

This is the end of detailed descriptions of the moving image data viewing process executed in the in-vehicle image output device 101 with reference to the flowchart.

As described above, in the in-vehicle image output device 101 of the present embodiment, the user does not have to view the same still image at the time of a screen switching performed when a moving image is reproduced. The reproduction of a piece of moving image data starts immediately after the screen switching is completed. As the result, the user would not feel any discomfort about being forced to wait until the reproduction of the piece of moving image data starts, or feel any anxiety about his or her device operating improperly. Furthermore, it becomes possible to start the reproduction of the piece of moving image data without causing the user to become visually bored due to the effect processing.

Note that in the present embodiment, the in-vehicle image output device 101 is installed in a vehicle. However, the present invention is not limited thereto. The in-vehicle image output device 101 may be installed in other mobile units. Or the same effect can be obtained even when the in-vehicle image output device 101 is installed in a house or the like. Furthermore, depending on the installation environment, wired communication may be used instead of wireless communication.

Furthermore, in the present embodiment, the in-vehicle image output device 101 is connected to the input section 108 and the display section 109. However, the in-vehicle image output device 101 may be integrated with the input section 108 and the display section 109 to act as a touch panel monitor. Furthermore, in the present embodiment, the DB managing section is an HDD. However, the present invention is not limited thereto. The DB managing section may be other recording media such as a semiconductor memory and a recordable optical disc medium.

Furthermore, in the present embodiment, the database file and a still image of a head frame corresponding to each of the pieces of moving image data managed in the database file are recorded in the HDD. However, other data may be recorded in the HDD.

Still furthermore, in the present embodiment, the moving image data menu screen displays the moving data list. However, a thumbnail image of each of the pieces of moving image data may be displayed.

Furthermore, the still image of the head frame corresponding to each of the pieces of moving image data managed in the database file may be downloaded from the storage location of each of the pieces of moving image data, instead of being recorded in the HDD. In the present embodiment, the database file is recorded in the DB managing section 104. However, in the case where the storage location of each of the pieces of moving image data is a moving image viewing site, information necessary for a database file may be downloaded from the moving image viewing site when an access is made, and the database file may be created every time an access is made.

Furthermore, in the present embodiment, the effective communication speed with respect to the content storing section 110 is measured after the effect processing controlling section 106 is instructed from the control section 105 to prepare to generate an effect processed image. The present invention is not limited thereto. For example, the effective communication speed may be measured at regular time intervals, e.g., at intervals of 30 seconds. Such a structure makes it possible to generate an effect processed image immediately after receiving an instruction to output image data of a content by means of the effect processing execution time having been calculated.

Furthermore, in the present embodiment, in a method of measuring the effective communication speed, a file having a certain specific size is transmitted, thereby calculating the effective communication speed by measuring a time period required until the file reception is completed. However, the present invention is not limited thereto. For example, in the case where a TCP (Transmission Control Protocol) communication is used, the effective communication speed can be calculated by transmitting aping (Packet INternet Grouper) command and measuring an RTT (Round Trip Time) in response to the ping command. Or the effective communication speed may be measured by using a known method other than the methods mentioned above.

Furthermore, in the present embodiment, the content storing section 110 is installed in a house as the server 1 and the server 2. However, the present invention is not limited thereto. The content storing section 110 may be a portable terminal carried by the user. Or the same effect can be obtained by using a moving image viewing site on the Internet.

Furthermore, in the present embodiment, the effect processed image is shifted to the right as a wipe image. However, the wipe image may be of other types. Or even in the case of a screen switching to which other special effects are applied, the same effect can be obtained if the effect processing execution time is set to be controlled.

Furthermore, in the present embodiment, the first still image is shifted to the second still image at a uniform speed in the effect processed image. However, the present invention is not limited thereto. The same effect can be obtained even when the first still image is shifted to the second still image at a non uniform speed.

Furthermore, in the present embodiment, an amount of data corresponding to five seconds is buffered for reproducing each of the pieces of moving image data. However, the present invention is not limited thereto. An appropriate amount may be set in accordance with a performance of the decoding section 103.

Furthermore, in the present embodiment, the effect processing execution time is calculated by means of the effective communication speed with respect to the storage location of each of the pieces of moving image data. However, in addition to the aforementioned effective communication speed, a decoding processing time of the decoding section 103 and a rendering processing time required until an image is displayed on the display section 109 may also be considered.

Furthermore, in the present embodiment, the contents such as the moving image data are stored in the content storing section 110. The present invention is not limited thereto. The contents may be stored in an accumulation section included in the in-vehicle image output device 101. In this case, the effect processing execution time may be calculated taking into consideration a speed of reading data to be buffered.

Furthermore, the present embodiment illustrates an example where the moving image data is used. However, the present invention is not limited thereto. For example, even when using music data, the same effect can be obtained when a dedicated image is displayed while reproducing the music data. Or the same effect can be obtained when a switching is performed to another menu screen, for example.

The above embodiment merely illustrates an example of the detailed structure of the present invention. It is understood that the above-described structure does not limit the technical scope of the present invention. Any structure can be adopted within the scope exerting the effect of the present invention.

### INDUSTRIAL APPLICABILITY

As described above, an image output device according to the present invention allows a user not to feel any discomfort about being forced to wait until the reproduction of a content such as moving image data starts, or not to feel any anxiety about his or her device operating improperly. Furthermore, it becomes possible to start the reproduction of the moving image data without causing the user to become visually bored due to the effect processing. Therefore, the image output device according to the present invention is applicable to a display control of screen switching performed when the reproduction of a content accumulated in a content storing section is started, for example.

1. An image output device which outputs a plurality of pieces of image data of contents having been accumulated, the image output device comprising:
a display section for displaying one of the pieces of the image data;
an input section for receiving an operation of a user;
an effect processing controlling section for calculating, before the user selects a predetermined content through the input section, an effect processing execution time indicating a time period required for executing an effect processed image displayed while a screen switching is performed based on a time period required for retaining buffered data corresponding to an amount sufficient to reproduce each of the pieces of image data of the contents;
an effect processed image generating section for generating the effect processed image in accordance with the effect processing execution time; and
a control section for displaying the effect processed image in the display section.

2. The image output device according to claim 1, further comprising a communication section for acquiring, via a network, the contents having been accumulated in a content storing section installed at a remote location, wherein
the effect processing controlling section calculates the effect processing execution time based on an effective communication speed between the communication section and the content storing section.

3. The image output device according to claim 2, wherein
the communication section acquires, via a network, the contents having been accumulated in content storing sections installed at a plurality of remote locations, and
the effect processing controlling section calculates the effect processing execution time corresponding to the effective communication speed between the communication section and each of the content storing sections.

4. The image output device according to claim 1, further comprising a content storing section for accumulating the contents, wherein
the effect processing controlling section calculates the effect processing execution time based on a time period required for reading buffered data corresponding to an amount sufficient to reproduce the one of the pieces of image data from the content storing section.

5. The image output device according to claim 1, wherein
the effect processing controlling section calculates the effect processing execution time at regular time intervals.

6. The image output device according to claim 1, further comprising a DB managing section for recording a database file which manages the contents having been accumulated, wherein
the DB managing section records still image data corresponding to each of the contents having been accumulated, and
the effect processed image generating section generates the effect processed image by means of the still image data.

7. The image output device according to claim 1, wherein
the image output device is installed in a mobile unit.

8. The image output device according to claim 2, wherein
the image output device is installed in a mobile unit.

9. The image output device according to claim 3, wherein
the image output device is installed in a mobile unit.

10. The image output device according to claim 4, wherein
the image output device is installed in a mobile unit.

11. The image output device according to claim 5, wherein
the image output device is installed in a mobile unit.

12. The image output device according to claim 6, wherein
the image output device is installed in a mobile unit.
